(19) United States
(12) Patent Application Publication
(10) Pub. No.: US 2006/0161808 A1
(43) Pub. Date: Jul. 20, 2006

(54) Method, apparatus and program storage device for providing intelligent copying for faster virtual disk mirroring

(76) Inventor: Todd R. Burkey, Savage, MN (US)

Correspondence Address: CRAWFORD MAUNU PLLC, 1270 NORTHLAND DRIVE, SUITE 390, ST. PAUL, MN, 55120, US

(21) Appl. No.: 11/037,317

(22) Filed: Jan. 18, 2005

(51) Int. Cl. G06F 11/00

(52) U.S. Cl. 714/6

(57) ABSTRACT

A method, apparatus and program storage device for providing intelligent copying for faster virtual disk mirroring is disclosed. The present invention provides a mirrored virtual disk by copying on a first virtual disk to a mirrored virtual disk without copying uninitialized regions of the first virtual disk.

### BACKGROUND OF THE INVENTION

1. Field of the Invention

This invention relates in general to virtual disk mirroring, and more particularly to a method, apparatus and program storage device for providing intelligent copying for faster and even instant virtual disk mirroring.

2. Description of Related Art

With the ever increasing amount of data being processed by today's computer systems, it is often desirable to have a mass storage subsystem to transfer large amounts of data to and from the computer system. Such a mass storage subsystem is commonly found in a local area network (LAN), wherein information and files stored on one computer, called a server, are distributed to local work stations having limited or no mass storage capabilities. Both its storage capacity and data transfer rate measure the mass storage subsystem's ability to meet the demands of the LAN. The need for very high data transfer rates can be readily appreciated given the high performance requirements of video graphic work stations used in computer aided design, animation work, and the ever increasing database sizes as the amount of data stored by companies doubles and sometimes even quadruples every year.

Conventional disk array data storage systems have multiple storage disk drive devices that are arranged and coordinated to form a single mass storage system. The common design goals for mass storage systems include low cost per megabyte, high input/output performance, and high date availability. Data availability involves the ability to access data stored in the storage system while ensuring continued operation in the event of a disk or component failure. Data availability is often provided through the use of redundancy where data, or relationships among data, are stored in multiple locations in the storage system. In the event of disk failure, redundant data is retrieved from the operable portion of the system and used to regenerate the original data that is lost due to the component failure.

There are two common methods for storing redundant data on disk drives: mirrored and parity. In mirrored redundancy, the data being stored is duplicated and stored in two separate areas of the storage system that are the same size (an original data storage area and a redundant storage area). In parity redundancy, the original data is stored in an original data storage area and the redundant data is stored in a redundant storage area, but because the redundant data is only parity data the size of the redundant storage area is less than the size of the original data storage area.

RAID (Redundant Array Independent Disks) storage systems are disk array systems in which part of the physical storage capacity is used to store redundant data. RAID systems are typically characterized as one of seven architectures or levels, enumerated under the acronym RAID. A RAID 0 architecture is a disk array system that is configured without any redundancy. Since the architecture is really not a redundant architecture, RAID 0 is often omitted from a discussion of RAID systems.

A RAID 1 architecture involves storage disks configured according to mirrored redundancy. Original data is stored on one set of disks and a duplicate copy of the data is kept on separate disks. The RAID 2 through RAID 6 architectures all involve parity-type redundant storage. Of particular interest, a RAID 5 architecture distributes data and parity information across all of the disks. Typically, the disks are divided into equally sized address areas referred to as “blocks.” A set of blocks from each disk that has the same unit address ranges is referred to as “stripes.” In RAID 5, each stripe has N blocks of data and one parity block that contain redundant information for the data in the N blocks.

In RAID 5, the parity block is cycled across different disks from stripe-to-stripe. For example, in a RAID 5 architecture having five disks, the parity block for the first stripe might be on the fifth disk; the parity block for the second stripe might be on the fourth disk; the parity block for the third stripe might be on the third disk; and so on. RAIDS 2 through RAID 4 architectures differ from RAID 5 in how they place the parity block on the disks.

A RAID 6 architecture is similar to RAID 4 and 5 in that data is striped, but is dissimilar in that it utilizes two independent and distant parity values for the original data, referred to herein as P and Q. The P parity is commonly calculated using a bit by bit Exclusive OR function of corresponding data chunks in a stripe from all of the original data disks. This corresponds to a one equation, one unknown, sum of products calculation. On the other hand, the Q parity is calculated linearly independent of P and using a different algorithm for sum of products calculation. As a result, each parity value is calculated using an independent algorithm and each is stored on a separate disk. Consequently, a RAID 6 system can rebuild data (assuming rebuild space is available) even in the event of a failure of two separate disks in the stripe, whereas a RAID 5 system can rebuild data only in the event of no more than a single disk failure in the stripe.

Similar to RAID 5, a RAID 6 architecture distributes the two parity blocks across all of the data storage devices in the stripe. Thus, in a stripe of N+2 data storage devices, each stripe has N blocks of original data and two blocks of independent parity data. One of the blocks of parity data is stored in one of the N+2 data storage devices, and the other of the blocks of parity data is stored in another of the N+2 data storage devices. Similar to RAID 5, the parity blocks in RAID 6 are cycled across different disks from stripe-to-stripe. For example, in a RAID 6 system using five data storage devices in a give stripe, the parity blocks for the first stripe of blocks may be written to the fourth and fifth devices; the parity blocks for the second stripe of blocks may be written to the third and fourth devices; the parity blocks for the third stripe of blocks may be written to the second and third devices; etc. Typically, again, the location of the parity blocks for succeeding blocks shifts to the succeeding logical device in the stripe, although other patterns may be used.

In the RAID architecture, multiple disks are typically mapped to a single “virtual disk.” Consecutive blocks of the virtual disk are mapped by a strictly defined algorithm to a set of physical disks with no file level awareness. When the RAID system is used to host a conventional file system, it is the file system that maps files to the virtual disk blocks where they may be mapped in a sequential or non-sequential order in a RAID stripe.

At initial creation of a virtual disk, the user usually knows that a VDisk should be mirrored. Alternately, via hints provided via an operating system controlled functionality the operating system may determine that a VDisk should be created with sufficient redundancy. The common approach is to create the virtual disks, then copy the virtual disks and then place the virtual disks into a mirrored state. On larger disks this “copy” operation can take hours.

Some systems take the approach of “snapshotting” the virtual disk. Snapshotting acts as if the copy is complete and then using push-ahead or pull-behind logic moves the data on demand. However, snapshotting does not quite solve the problem because a continuous data mirror for disaster recovery purposes is not provided. Rather, a number of point-in-time images are created.

It can be seen then that there is a need for a method, apparatus and program storage device for providing intelligent copying for faster virtual disk mirroring.

### SUMMARY OF THE INVENTION

To overcome the limitations described above, and to overcome other limitations that will become apparent upon reading and understanding the present specification, the present invention discloses a method, apparatus and program storage device for providing intelligent copying for faster virtual disk mirroring.

The present invention solves the above-described problems by creating a mirrored virtual disk by copying data on a first virtual disk to a mirrored virtual disk without copying uninitialized regions of the first virtual disk. The most important extension of this feature is simply the ability to instantly create a mirror of a newly created virtual disk (i.e. one that hasn't been written to yet by servers.) In the past, implementation of such a feature hasn't been practical due to some systems failures to properly track all data accesses, other systems inability to even mirror at the virtual disk level, and more commonly many peoples beliefs that both sides of a mirror must be exactly the same, even for regions that a server has never written to. This latter misconception is immediately dismissed when it is understood that normal raid 10 mirrors are typically never initialized by storage systems at creation, so both sides of a mirror in those cases will very likely contain mismatching (non-synchronized) data as well until written to by the operating system.

A method in accordance with the principles of the present invention includes creating a first virtual disk, creating a second virtual disk for mirroring the first virtual disk, tracking sectors that have been written to and copying data on the first virtual disk to the second virtual disk without copying uninitialized regions of the first virtual disk.

In another embodiment of the present invention, a disk controller is provided. The disk controller includes memory for storing data therein and a processor, coupled to the memory, for controlling access and configuration of data in a storage array, the processor being configured to create a first virtual disk, create a second virtual disk for mirroring the first virtual disk, track sectors that have been written to and copy data on the first virtual disk to the second virtual disk without copying uninitialized regions of the first virtual disk.

In another embodiment of the present invention, a program storage device is provided. The program storage device includes program instructions executable by a processing device to perform operations for providing intelligent copying for faster virtual disk mirroring, the operations including creating a first virtual disk, creating a second virtual disk for mirroring the first virtual disk, tracking sectors that have been written to and copying data on the first virtual disk to the second virtual disk without copying uninitialized regions of the first virtual disk.

In another embodiment of the present invention, another disk controller is provided. The disk controller includes means for storing data and means, coupled to the means for storing data, for controlling access and configuration of data in a storage array, the mans for controlling being configured to create a first virtual disk, create a second virtual disk for mirroring the first virtual disk, track sectors that have been written to and copy data on the first virtual disk to the second virtual disk without copying uninitialized regions of the first virtual disk.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of an apparatus in accordance with the invention.

### BRIEF DESCRIPTION OF THE DRAWINGS

Referring now to the drawings in which like reference numbers represent corresponding parts throughout:

FIG. 1 shows a Storage Area Network (SAN) according to an embodiment of the present invention;

FIG. 2 illustrates a storage disk array according to an embodiment of the present invention; and

FIG. 3 illustrates a flow chart of a method for providing intelligent copying for faster virtual disk mirroring according to an embodiment of the present invention.

### DETAILED DESCRIPTION OF THE INVENTION

In the following description of the embodiments, reference is made to the accompanying drawings that form a part hereof, and in which is shown by way of illustration of specific embodiments in which the invention may be practiced. It is to be understood that other embodiments may be utilized because structural changes may be made without departing from the scope of the present invention.

The present invention provides a method, apparatus and program storage device for providing intelligent copying for faster virtual disk mirroring. The present invention provides a mirrored virtual disk by copying data on a first virtual disk to a mirrored virtual disk without copying uninitialized regions of the first virtual disk.

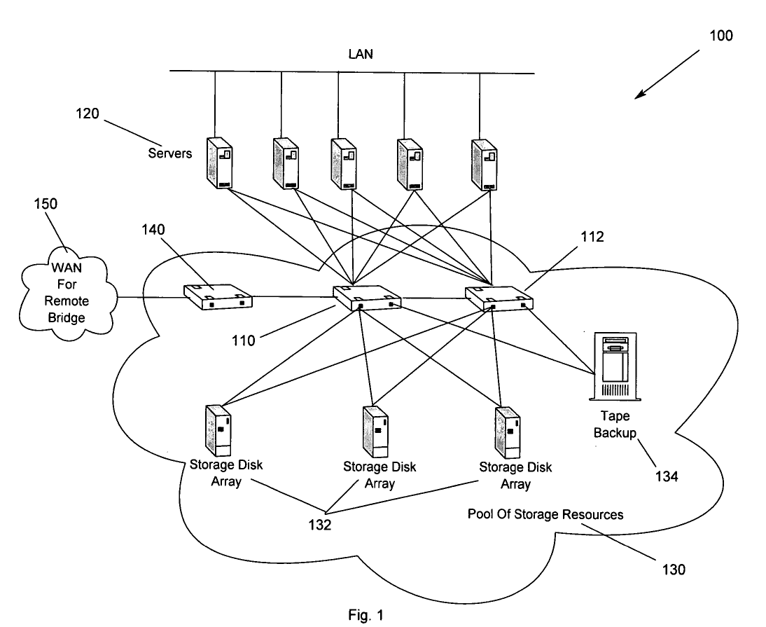

FIG. 1 shows a Storage Area Network (SAN) 100 according to an embodiment of the present invention. In FIG. 1, the SAN 100 includes two Fibre Channel switches 110, 112 for connecting a server cluster 120 to a pool of storage resources 130. The Fibre Channel Protocol specifies how to run the SCSI command set over a dedicated Fibre Channel optical fabric. In direct server attached storage, a local SCSI controller on the PCI-X bus fulfills a data request initiated by the SCSI driver in the host server. With FCP, a Fibre Channel host bus adapter (HBA) replaces the SCSI controller in each server 120 to connect to the SAN fabric 110, 112, which in turn connects to disk arrays 132 and tape drives 134.

The pool of storage resources 130 may include a plurality of storage disk arrays 132 and tape backup units 134. The SAN 100 may also include a Fibre Channel over Internet Protocol (FCIP) gateway 140 for remote data backup and disaster recovery over a wide area network (WAN) 150. The server cluster 120 is accessible by a host (not shown) via the local area network (LAN). The SAN 100 centralizes all storage into a virtual pool. This centralized pool of storage resources 130 offers performance equal or better than direct server attached storage, and is completely transparent to the host operating system.

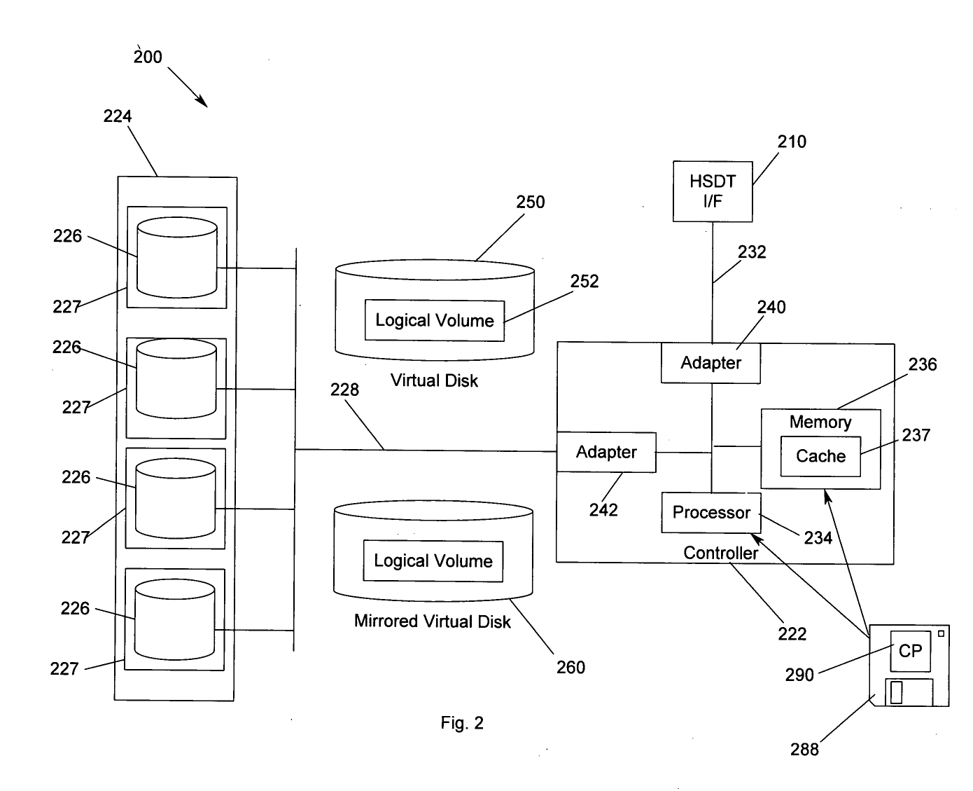

FIG. 2 illustrates a storage disk array 200 according to an embodiment of the present invention. In FIG. 2, the storage disk array 200 includes a controller 222 and an array 224 of independent disk drives 226. The disk drives 226 may be implemented in a structure 227 including a drive controller (not shown). Each disk drive 226 may be accessed by a separate channel. The storage array controller 222 includes high-performance processors 234 in a server-like architecture for ensuring data integrity and hiding disk latencies through caching 237. The storage array controller 222 connects to the high-speed data transfer interface 210 and to disk adapters (not shown) of the disk array 224.

The controller 222 is responsible for the features and functions of the storage array 224 and can optionally execute a RAID software stack. The controller 222 operates in accordance with the present invention to selectively map data to one group 227 of the disk drives 226 and to provide intelligent copying for faster virtual disk mirroring. The controller 222 is connected to the array 224 by way of one or more communications cables such as cable 228.

The controller 222 comprises a processor 234 and memory 236 providing at least one cache 237. The memory 236 and the processor 234 are connected by a controller bus 238 and operate to control the mapping algorithms for the disk array 224. The controller 222 communicates with a high-speed data transfer interface 210 through an adapter 240 and link 232. The controller 222 similarly communicates with the disk array 224 through adapter 242, which is connected to cable 228. In one embodiment, adapter 242 may be a Small Computer System Interface (SCSI) adapter and adapter 240 may be a Fibre Channel Interface adapter.

The disk array 224 is a collection of disk drives 226 which are relatively independent storage elements, capable of controlling their own operation and responding to input/output (I/O) commands autonomously, which is a relatively common capability of modern disks. The particular disk drives 226 may be either magnetic or optical disks and are capable of data conversion, device control, error recovery, and bus arbitration; i.e., they are intelligent storage elements similar to those commonly found in personal computers, workstations and small servers. The disk drives 226 may further provide block-addressable random read/write access to data storage.

Data is transferred to and from the disk array 224 via cable 228. The cable 228 essentially moves commands, disk responses and data between the I/O bus adapter 242 and the disk array 224. In an embodiment, the cable 228 represents one or more channels comprising one or more SCSI buses. Alternatively, the cable 228 may be a collection of channels that use some other technology.

Adapter 240 provides an interface between the high-speed data transfer interface 210 and line 232. In alternative embodiments, the controller 222 may be incorporated along with the disk array 224. However, the controller 222 is shown separately here and represents an intelligent controller, which is interposed between a high-speed data transfer interface 210, such as switched fibre channel, point to point or arbitrated loop topologies, and the disk drives 226. In this configuration, the intelligent controller 222 facilitates the connection of larger numbers of disks 226 and other storage devices to a high-speed data transfer interface 210.

One function of the processor 234 is to present information on the disk drives 226 to the high-speed data transfer interface 210 as at least one virtual disk 250, which includes at least one virtual disk volume 252. The virtual disk 250 may also be referred to as a logical unit, wherein the logical unit may be identified by a logical unit number (LUN). The virtual disk 250 is a set of disk blocks presented to an operating environment as a range of consecutively numbered logical blocks 252 with disk-like storage and I/O semantics. The virtual disk 250 is the disk array object that most closely resembles a physical disk from the operating environment's viewpoint.

The processor 234 may be configured with a tracking feature for monitoring sectors on the disk array 224 that have been written to. As described above, at initial creation of a virtual disk 250, the user may want to create a mirrored VDisk 260. The common approach is to create the virtual disk 250, copy the virtual disks to the mirrored virtual disk 260 and then place the virtual disks into a mirrored state. On larger disks this copy operation can take hours.

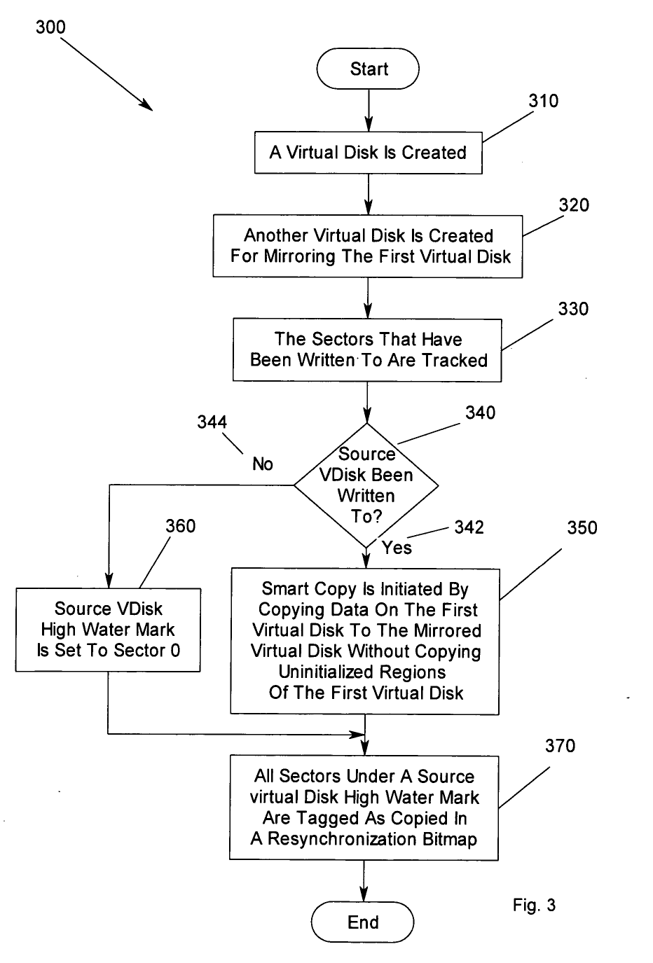

FIG. 3 illustrates a flow chart 300 of a method for providing intelligent copying for faster virtual disk mirroring according to an embodiment of the present invention. First, a virtual disk is created 310. Another virtual disk is created for mirroring the first virtual disk 320. The sectors that have been written to are tracked 330. A determination may be made to determine whether any write has occurred since virtual disk creation to ensure that a truly uninitialized vdisk can be instantly mirrored to another uninitialized virtual disk 340. This provides a safe mode, which may or may not be designed to carry over reboots of the storage controller. This safe mode would accommodate OS's and some applications that may store checksums or other forms of validation of sectors that the OS or applications has read, but never actually written. A less safe, but potentially useful mode would be to deal with tracking data access regions. If the source virtual disk has been written to 342, smart copy is initiated by copying data on the first virtual disk to the mirrored virtual disk without copying uninitialized regions of the first virtual disk 350. If the source vitual disk has not been written to 344, the smart copy is skipped and the source high water mark is set to sector zero 360.

The tracking feature dramatically reduces the initial copy time on large virtual disk mirrors by eliminating the need to copy the uninitialized regions of the first virtual disk. This can reduce an initial copy from many hours to several seconds if no sectors have been written to yet on the source virtual disk (i.e. if it hasn't been assigned to a server yet). All sectors under a source virtual disk high water mark are tagged as copied in a resynchronization bitmap 370. Validation of high water mark can be via any write access. Validation of high water mark can be carried over reboots of a system and multiple windows of access could be maintained on very large virtual disks.

Referring to FIG. 2 again, the process described with reference to FIGS. 1-3 may be tangibly embodied in a computer-readable medium or carrier, e.g. one or more of the fixed and/or removable data storage devices 228 illustrated in FIG. 2, or other data storage or data communications devices. The computer program 290 may be loaded into memory 220 to configure the processor 234 for execution. The computer program 290 include instructions which, when read and executed by a processor 234 of FIG. 2 causes the processor 234 to perform the steps necessary to execute the steps or elements of the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather by the claims appended hereto.

What is claimed is:

1. A method for providing intelligent copying for faster virtual disk mirroring, comprising:
creating a first virtual disk;
creating a second virtual disk for mirroring the first virtual disk;
tracking sectors that have been written to; and
copying data on the first virtual disk to the second virtual disk without copying uninitialized regions of the first virtual disk.

2. The method of claim 1 further comprising tagging all sectors under a source virtual disk high water mark as copied in a resynchronization bitmap.

3. The method of claim 2 further comprising validating the high water mark.

4. The method of claim 3, wherein the validating the high water mark comprising validating the high water mark via a write access.

5. The method of claim 3 further comprising carrying the validation of the high water mark over reboots of a system.

6. The method of claim 3 further comprising providing a safe mode that assumes all blocks of a virtual disk are dirty and need to be recopied if any sector is written to on the source vdisk prior to the mirror operation.

7. A disk controller, comprising:
memory for storing data therein; and
a processor, coupled to the memory, for controlling access and configuration of data in a storage array, the processor being configured to create a first virtual disk, create a second virtual disk for mirroring the first virtual disk, track sectors that have been written to and copy data on the first virtual disk to the second virtual disk without copying uninitialized regions of the first virtual disk.

8. The controller of claim 6, wherein the processor tags all the sectors under a source virtual disk high water mark as copied in a resynchronization bitmap.

9. The controller of claim 7, wherein the resynchronization bitmap is stored in the memory.

10. The controller of claim 7, wherein the processor validates the high water mark.

11. The controller of claim 9, wherein the processor carries the validation of the high water mark over reboots.

12. A program storage device, comprising:
program instructions executable by a processing device to perform operations for providing intelligent copying for faster virtual disk mirroring, the operations comprising:
creating a first virtual disk;
creating a second virtual disk for mirroring the first virtual disk;
tracking sectors that have been written to; and
copying data on the first virtual disk to the second virtual disk without copying uninitialized regions of the first virtual disk.

13. The program storage device of claim 11 further comprising tagging all sectors under a source virtual disk high water mark as copied in a resynchronization bitmap.

14. The program storage device of claim 12 further comprising validating the high water mark.

15. The program storage device of claim 13, wherein the validating the high water mark comprising validating the high water mark via a write access.

16. The program storage device of claim 13 further comprising carrying the validation of the high water mark over reboots of a system.

17. A disk controller, comprising:
means for storing data; and
means, coupled to the means for storing data, for controlling access and configuration of data in a storage array, the means for controlling being configured to create a first virtual disk, create a second virtual disk for mirroring the first virtual disk, track sectors that have been written to and copy data on the first virtual disk to the second virtual disk without copying uninitialized regions of the first virtual disk.
